(19) United States
(12) Patent Application Publication
(10) Pub. No.: US 2024/0293213 A1
(43) Pub. Date: Sep. 5, 2024

(54) ORAL POUCH FOR DELIVERING ACTIVE INDREDIENTS

(71) Applicant: pely-tex GmbH & Co. KG, Wahlstedt (DE)

(72) Inventors: Henning Roettger, Kaltenkirchen (DE); Sebastian Kunzet, Henstedt-Ulzburg (DE)

(73) Assignee: pely-tex GmbH & Co. KG, Wahlstedt (DE)

(21) Appl. No.: 18/574,987

(22) PCT Filed: Jun. 28, 2022
(86) PCT No.: PCT/EP2022/067658

§ 371 Date: Dec. 28, 2023

(30) Foreign Application Priority Data
Jul. 1, 2021 (EP) 21183308.2

(51) Int. Cl. A61C 19/02; A23L 27/00

(52) U.S. Cl. CPC A61C 19/02; A23L 27/72

(57) ABSTRACT

A pouch for placement in an oral vestibule of a human for absorption of an active ingredient includes a pouch sleeve comprised of a material which is permeable to saliva, an active ingredient composition including caffeine and taurine, and an imprint positioned on an exterior surface of the pouch sleeve. The imprint, the permeability of the material of the pouch sleeve, and the active ingredient composition are configured such that, because of an effect of the saliva, the imprint is gradually released from the exterior surface of the pouch due to contact with the saliva. The saliva extracts the active ingredient composition from the pouch and fades the imprint so the imprint is no longer visually perceptible just when the active ingredient composition is substantially or completely extracted from the pouch. The imprint acts as a visual indicator of a consumption status of the active ingredient.

### CROSS REFERENCE TO RELATED APPLICATIONS

This application is a national stage application pursuant to 35 U.S.C. § 371 of International Application No. PCT/EP2022/067658, filed on Jun. 28, 2022, which claims priority to and the benefit of European Patent Application No. 21183308.2, filed on Jul. 1 2021, the entire contents are hereby incorporated by reference.

### TECHNOLOGICAL FIELD

The invention relates to an oral pouch for placement in the oral vestibule for absorption of an active ingredient or an active ingredient composition by a human.

### BACKGROUND

In today's society, the need for overcoming tiredness and getting a short-term boost in performance is increasingly widespread at work and during leisure time. Increasing value is placed on mobility, so that hot drinks such as coffee are not always suitable for stimulating and boosting performance. In this regard, so-called energy drinks such as Red BullR or Monster® which contain relatively high concentrations of active ingredients like caffeine and taurine, have become established. These energy drinks are sold in cans of sheet metal and are relatively easy to carry along. In addition to energy drinks, there are also increasingly sweets (candies) with a high caffeine content which drivers like to use against fatigue.

Carrying beverage cans is not very advantageous in the field of sports and other activities, for example during a long-distance run, climbing, etc. Eating candies can also be critical in sports or other physical exertion since the risk exists of them entering the windpipe.

WO 2010/114445 A1 describes a plant fiber product which comprises a mixture that contains at least plant fibers and at least one additional substance which is to be released from the product during use. The product contains an alginate composition which is dispersed in the product and comprises at least water, alginate and the additional substance. The composition contains an alginate matrix and retains at least the majority of the additional substance as long as the matrix is intact. The alginate matrix is formed such that it disintegrates and/or dissolves in the chemical and physical environment in a mouth of a user. The additional substance is, for example, caffeine. The product can be placed in the mouth of the user like moist snuff tobacco, for example under the lips. The product can be packaged in boxes in loose form or in the form of sachets, like pinches of snuff tobacco.

Against this backdrop, the object of the invention is to provide a stimulant in a form that enables easy transport, does not require the supply of liquid, and can also be taken safely during physical activities during which absorption is difficult or impossible using conventional formats such as beverage cans, candies or powders.

### BACKGROUND

An embodiment of an oral pouch for placement in the oral vestibule for absorption of an active ingredient composition by a human includes a pouch sleeve made of a material which is permeable to saliva, and an active ingredient composition containing caffeine and taurine.

Portioned snus is an established form of administration of nicotine-containing substrates (generally tobacco or also synthetic nicotine-containing substitutes) which are packaged in a small pouch and held by the user between the gingiva and lip or cheek. The material of the pouch is permeable to saliva so that the nicotine and flavorings are extracted from the substrate and quickly enter the bloodstream of the user through the mucous membranes, or respectively through the stomach and manifest their effect there.

In an embodiment, an active ingredient composition containing or consisting of taurine and caffeine is incorporated into this packaging format. Accordingly, this active ingredient composition can also be easily transported by athletes and other persons and can also be safely positioned in the mouth during active physical activity so that the active ingredients can be absorbed via the saliva. By the release of the mixture consisting of taurine and caffeine in the oral cavity in direct contact with the oral mucosa, the active ingredients can be absorbed by the body without coming into contact with the gastric acid as is the case with energy drinks. It is therefore also possible to absorb active ingredients that are sensitive to gastric acid. During activities, people (athletes) have to carry the small pouch with them, but not a can of liquid. The active ingredients are released over a longer period of time from the pouch securely fixed in the oral cavity. In contrast to a candy, the pouch cannot be accidentally swallowed during activity or even enter into the respiratory tract. This is especially of importance for athletes etc. In comparison to a powder, the active ingredient composition packed in an oral pouch can be released by the saliva and safely absorbed without additional liquid.

According to an embodiment, the active ingredient composition comprises one or more of the following additional ingredients: sugar, dextrose, sweetener, carbonic acid, citric acid, sodium citrate, glucuronolactone, vitamins (e.g. vitamin B6 and/or vitamin B12), mineral substances, flavoring agents, nicotine, niacin, nicotinamide, acetylsalicylic acid, and colorant. According to another embodiment of the invention, the active ingredient composition comprises the combination of caffeine and acetylsalicylic acid, because this increases the efficiency of the acetylsalicylic acid.

As already noted, the active ingredient composition preferably comprises active ingredients sensitive to gastric acid. These are active ingredients which, before they enter the bloodstream of the user through the stomach, are substantially or completely broken down by the stomach acid so that they cannot manifest their effect in the bloodstream.

According to one embodiment, the active ingredient composition consists of caffeine and taurine, or the active ingredient composition consists substantially of caffeine and taurine. According to another embodiment, the active ingredient composition consists of caffeine, taurine and sugar, or the active ingredient composition substantially consists of caffeine, taurine and sugar.

According to another embodiment, the active ingredient composition is contained in a certain dose in the pouch. In another embodiment, the dose comprises the following amounts of ingredients:
50 to 120 mg caffeine, preferably 70 to 90 mg caffeine, preferably 80 mg caffeine; and/or 0.5 to 1.5 g taurine, preferably 0.8 to 1.2 g taurine, preferably 1 g taurine; and/or 15 to 40 g sugar, preferably 20 to 30 g sugar, preferably 25 g sugar. The above amounts are hereinafter referred to as a “strong dose”.

According to another embodiment, the pouch contains the active ingredient composition in a dose that is less than the strong dose. According to additional embodiments, the amounts of the active ingredients in the oral pouch are three-quarters, or one-half, or one-eighth, or one-tenth, or one-twentieth of the above amounts of the strong dose. Various oral pouches with a graded dose of the active ingredient composition can be thereby provided.

According to another embodiment, the active ingredient composition is designed and constituted such that it dissolves in the saliva during a given exposure time, preferably around one hour, preferably from one to 40 minutes, preferably from five to 30 minutes, whereby the active ingredient composition is released until the end of the given exposure time. According to another embodiment, the active ingredient composition is designed and constituted such that it dissolves according to given kinetics. In particular, this can ensure that the active ingredient composition is released quickly, delayed or slowed down (retarded) by dissolving.

According to another embodiment, the pouch comprises granules which consist of or contain the active ingredient composition. According to another embodiment, the pouch sleeve has an average pore size that falls below the average particle size of the particle size distribution of the granules. According to another embodiment, the average pore size of the pouch sleeve is smaller than the 0.25 quantile, and preferably smaller than the 0.1 quantile of the particle size distribution of the granules. This ensures that the pouch completely or almost completely retains the granules so that the active ingredient composition is only transported out of the pouch through the pouch sleeve dissolved in the saliva.

The average pore size of the pouch sleeve is measured optically, preferably with the assistance of a (light) microscope. The average pore size is determined as the arithmetic mean of the measured pore sizes.

The particle size distribution of the granules is measured optically, preferably with the assistance of a (light) microscope.

The release of the active ingredient composition can be controlled in particular by the composition, particle size distribution or a coating of the granules.

According to another embodiment, taurine is contained in the form of a powder in the granules. Taurine is a colorless crystalline substance that decomposes at temperatures starting at 300° C. and melts at a temperature of 328° C. The taurine can be added to the active ingredient composition in the form of a powder consisting of crystalline particles.

According to another embodiment, the caffeine is contained in the granules in the form of a powder. For this purpose, for example commercially available 100% pure caffeine powder of pharmaceutical quality can be used.

According to another embodiment, the active ingredient composition comprises an additive, and/or a filler, and/or an excipient.

According to another embodiment, the additive is another active ingredient or other ingredient of the active ingredient composition, and/or the filler is an inert filler. According to another embodiment, the additive is contained in the granules in the form of a powder, and/or the filler is contained in the granules in the form of a powder, and/or the excipient is contained in the granules in the form of a powder. According to another embodiment, the additive is sugar or another ingredient of the active ingredient composition.

According to another embodiment, taurine and/or caffeine is introduced into the pouch sleeve in the form of granules mixed with an additive or filler.

According to another embodiment, the caffeine and/or the taurine is applied to an excipient, and the excipient loaded with caffeine and/or taurine is arranged in the pouch sleeve. To this end, for example, caffeine and/or taurine is applied to the excipient from a solution, and the solvent is removed. The excipient is, for example, granules.

According to another embodiment, the granules comprise cellulose fiber pulp. This can be mixed with caffeine and/or taurine in the form of granules or used as an excipient for caffeine and/or taurine. Cellulose fiber pulp is a biological product and suitable for being mixed with food and stimulants.

According to another embodiment, the granules comprise plant fibers as an additive or filler or as an excipient for caffeine and/or taurine.

According to another embodiment, the granules comprise plant fibers which are loaded with active ingredients and/or other ingredients.

According to another embodiment, the granules comprise plant fibers which contain caffeine and/or taurine and/or other ingredients as original constituents.

According to another embodiment, the pouch sleeve consists of a nonwoven.

According to another embodiment, the nonwoven comprises cellulosic fibers, or substantially or exclusively cellulosic fibers.

According to another embodiment, the cellulosic fibers comprise one or more of the following fibers: viscose fibers, lyocell fibers, and cotton fibers.

According to another embodiment, the nonwoven is chemically solidified. This can prevent undesired damage to the nonwoven from saliva, and the active ingredient composition from leaving the pouch.

According to another embodiment, the nonwoven contains a sealable component. By sealing the nonwoven, the pouch formed therefrom can be closed.

Details about nonwovens which can be used as a material for the pouch sleeve of the oral pouch according to the invention are described in the European patents EP 3 192 380 B1 and EP 3 223 636 B1. In this regard, reference is made to the European patents EP 3 192 380 B1 and EP 3 223 636 B1 whose content is hereby incorporated into this application.

The nonwoven is, for example, the product “Nonwova CV 29/viv” which is distributed by the company pely-tex GmbH & Co. KG, Willy-Pelz-Str. 2-4, 23812 Wahlstedt, Germany.

According to another embodiment, the permeability of the nonwoven is set in particular by at least one of the following measures: Selection of the fleece forming process, selection of the type, the titer and the cross-section of the fibers, selection of the type and amount of the binder, adjustment of the pore size distribution and the pore density of the nonwoven by compaction of the nonwoven. By means of the selection of the nonwoven and the adjustment of the permeability to saliva of the nonwoven pouch, the release of the active ingredient composition can be controlled. In particular, by adjusting the permeability of the nonwoven, a controlled and uniform discharge of the active ingredient composition can also be ensured over a longer time period. This is not possible during activity with the conventional format of the beverage can.

According to another embodiment, the nonwoven comprises fibers based on cellulose, a binder on the surface of the fibers, compacted zones and non-compacted zones, and the binder is, at least in the compacted zones, completely or partially crosslinked and holds the compacted zones in the compacted state.

Nonwovens suitable for snus pouches (e.g. consisting of chemically bound fibers containing viscose) are distinguished by their thermal sealability, or respectively sealability under high pressure. Conventionally for snus pouches, nonwovens with a maximum permeability to flavorings are used. Such a material has a relatively open pore structure. By locally pressing (embossing) the material in a simple calendaring process using an engraving roller (embossing roller) and a smooth roller, the nonwoven can be compacted in one or more defined zones, and the pore structure in the region of the one or more compacted zones can be thereby closed. The nonwoven is a textile fabric, and the compacted zones are formed by compacting the nonwoven in a perpendicular direction to the two main directions of extension of the nonwoven. The binder, at least in the compacted zones, is completely or partially cross-linked, whereby the compacted zones are secured, or respectively fixed in the compacted state. This can be achieved in that, when compressing the nonwoven, the binder is completely or partially cross-linked in the compacted zones because of an increase in pressure and temperature. The cross-linking can be brought about by an increase in the temperature of the rollers from the heat released by means of the rollers while pressing, and/or by the intentional supply of heat. The nonwoven is lastingly compacted in the compacted zones and kept closed. The compacted and closed zones stay mostly compacted and closed even in a wet state during oral use. Accordingly, the compacted zones have a lesser permeability in comparison to the uncompacted zones of the nonwoven. The permeability (passage of the saliva with flavors of the tobacco material) of the nonwoven in the compacted zones can be negligibly low. In the non-compacted zones, the permeability is, however, not or only partially decreased by compaction of the fibers so that the nonwoven is able to retain its original or only partially reduced permeability there.

By an intentional selection of the compacted and uncompacted zones, the overall permeability of the nonwoven in comparison to the employed starting material can be reduced and adapted to the respective tobacco materials, or respectively tobacco substitutes contained in the snus pouch. By an intentional selection of the structure of the compacted zones (embossed structure), not only can the permeability to flavorings be adjusted, but the flexural rigidity, elongation, and strength in the longitudinal and transverse direction can also be influenced and, by the adjustment of the three-dimensional surface structure, the roughness and therefore the feel of the pouch upon removal from the pack and during oral use can be intentionally modeled.

The intentional adjustment of the cited nonwoven properties by local compaction and solidifying of the nonwoven can also be used to intentionally influence the visual appearance of the nonwoven and therefore produce visually diversified snus pouches. To influence the permeability, basically only the share of compacted zones of the entire surface of the nonwoven is decisive. This leaves a lot of design leeway to emboss different structures in the nonwoven in a given surface of compacted zones and therefore embossing products with a tailored look (e.g. textile look, perforated look, look of leather or other materials) or the manufacturer's name, the brand, a logo, a club crest, or another identification.

It is very advantageous that the diversified properties of the nonwoven can be adjusted in a subsequent, less complex processing step, wherein the same nonwoven can always be used as the starting product.

According to one embodiment of the invention, the nonwoven is a chemically solidified nonwoven. In the chemically solidified nonwoven, the fibers are bound to each other at contact points by a binder applied thereto. The chemically solidified nonwoven includes a chemical binder. The chemical binder is an at least partially cross-linkable binder. When crosslinking the binder, long-chain molecules, which can be crosslinked to each other and form a polymer, are formed from monomers or short-chain molecules. According to one embodiment, the compacted zones are permanently fixed in the compacted state by the same binder. For this purpose, during the production of the nonwoven, a binder can be used which chemically cross-links while drying to form a thermoset and binds the fibers to each other at the contact points, wherein however the cross-linking is only partial, so that still cross-linkable components remain. When compacting the nonwoven by embossing, the pressure and the temperature can be locally increased so that the binder cross-links in the region of the embossing zones and forms a permanently compacted structure that possesses a certain wet strength.

According to another embodiment, the nonwoven is a mechanically solidified nonwoven. According to another embodiment, the nonwoven is mechanically solidified by needling or by water jets. The mechanically solidified nonwoven is also provided with the binder. The compacted zones are permanently kept in the compacted state by cross-linking the binder.

According to one embodiment, the pouch has sealing seams in which mutually overlapping regions of the nonwoven are connected to each other by a cross-linked binder. To this end, the binder is cross-linked by using pressure and temperature on the nonwoven when sealing the sealing seams. Non-crosslinked binder of the nonwoven can be used to produce the sealing seams. These can be non-crosslinked parts of the binder in the compacted and/or the non-compacted zones.

For the sake of simplified expression, it states above that the pouch comprises a nonwoven with compacted zones and non-compacted zones. This denotes both embodiments in which the nonwoven of the pouch comprises a plurality of compacted zones and a plurality of non-compacted zones, as well as embodiments in which the nonwoven comprises a plurality of compacted zones and just one non-compacted zone, or just one compacted zone and a plurality of non-compacted zones, or just one compacted zone and one non-compacted zone.

According to one embodiment, the nonwoven comprises a plurality of separate compacted zones within a contiguous non-compacted zone. In this embodiment, the non-compacted zone forms a contiguous main surface in which the separate compacted zones are arranged.

According to one embodiment, the nonwoven comprises a plurality of separate non-compacted zones within a contiguous compacted zone. In this embodiment, the contiguous compacted zone forms a main area in which the separate non-compacted zones are arranged.

According to another embodiment, the nonwoven comprises a plurality of compacted zones and a plurality of non-compacted zones between the compacted zones. For example, the compacted zones and the non-compacted zones are arranged like a chessboard, wherein the compacted zones are arranged like the dark areas, and the compacted zones are arranged like the light areas of the chessboard pattern.

According to another embodiment, different sections of the nonwoven have compacted and non-compacted zones formed in various above-described ways. For example, the one side of the pouch is formed in a different way than the other side.

According to another embodiment, the compacted zones and/or the non-compacted zones have one or more of the following shapes: polygonal, circular, oval, cruciform, strip-shaped, wavy (e.g. in the form of a sinusoidal, rectangular, triangular or sawtooth oscillation).

According to another embodiment, the pouch has a sealing seam running in the longitudinal direction on one large-area side in an overlapping region of the nonwoven, and sealing seams running in the transverse direction on the two transverse sides in the overlapping regions of the nonwoven. At the sealing seams running in the longitudinal and in the transverse direction, the pouch can be produced with high output quantities as a tubular pouch.

According to another embodiment, the pressed zones consume 5% to 95% of the surface of the nonwoven, and the non-compressed zones consume 95% to 5% of the surface of the nonwoven.

According to another embodiment, the dry nonwoven, in the machine direction, has a strength of 10 to 100 N/50 mm, and/or in the transverse direction, a strength of 5 to 50 N/50 mm.

The strengths are based on a determination according to EDANA WSP 110.4.

According to another embodiment, the dry nonwoven has, in the machine direction, an elongation of 5 to 50%, and transverse to the machine direction, an elongation of 10 to 100%.

The elongations are based on a determination according to EDANA WSP 110.4.

Details of a pouch with a pouch sleeve consisting of a nonwoven with compacted zones and non-compacted zones to control the porosity and methods for producing such a pouch are described in European patent application EP 21 183 302.5 of Jul. 1, 2021. In this respect, reference is made to European patent application EP 21 183 302.5 whose content is hereby incorporated into this application.

According to another embodiment, the pouch sleeve is a porous film. The permeability of the pouch sleeve to saliva and therefore the release of the active ingredient can be controlled by the porosity.

According to another embodiment, the pouch sleeve has an imprint consisting of a food-safe ink. By using the imprint, for example a manufacturer of energy drinks can diversify the product and communicate with the consumer by visual signals on the pouch. For the application of stimulants or flavorings, additional advantageous properties can be implemented by means of a printed oral pouch:

A brand image can be communicated by printing the pouch sleeve, which is advantageous especially for manufacturers of energy drinks.

By printing with a suitable ink which is slowly washed out by the saliva, a type of consumption display can be implemented which signals by the fading that the active ingredient is being consumed.

According to another embodiment, the imprint, the permeability of the material of the pouch sleeve, and the active ingredient composition are designed and constituted such that, because of the effect of saliva, the imprint is gradually released from the pouch surface and is no longer visually perceptible just when the active ingredient composition is extracted by the saliva from the pouch to a given extent, preferably completely or substantially, and accordingly renders visible the consumption status of the active ingredient.

According to another embodiment, the hydrophilicity/hydrophobicity of the nonwoven is adjusted by an imprint. By adjusting the hydrophilicity/hydrophobicity, the wetting ability of the pouch with saliva is adjusted, and the release of the active ingredient composition is thereby controlled.

In addition, the invention comprises an associated method for the oral absorption of an active ingredient, wherein an oral pouch according to one of the embodiments is placed in the oral vestibule, the active ingredient composition is extracted from the oral pouch by means of saliva, is absorbed through the mucous membranes and/or the stomach, and enters the bloodstream of the user and manifests its stimulating effect.

According to another embodiment, the active ingredient composition and the color of the imprint are released from the pouch sleeve at the same time by means of the saliva, wherein just when the imprint on the pouch surface is no longer visually perceptible, the active ingredient composition is exhausted by a specific amount or completely.

Finally, the invention comprises the use of a pouch according to one of the disclosed embodiments during long distance running, climbing, or any other endurance or trending sport, in which the pouch is placed in the oral vestibule, the active ingredient composition is extracted by means of saliva from the oral pouch, absorbed through the mucous membranes and/or the stomach, and enters the bloodstream of the user and manifests its stimulating effect.

By means of the pouch, the absorption of stimulating agents while performing such physical activities is possible in order to support said activities over a longer time period without the user having to carry a beverage bottle or another interfering object, wherein the danger of swallowing is greatly reduced.

In the following, embodiments of the invention and their advantageous features are presented. A preferred material for producing the oral pouch are sealable nonwovens that are produced using the wetlaid or chemical bonding process and are given sealable components. Especially these technologies enable the production of nonwovens which are spontaneously wettable with saliva (generally from a share of cellulosic fibers) and have a permeability to saliva.

Pouches for active ingredients whose permeability to saliva and matter dissolved therein is adjusted such that the active ingredients are released over a defined time period in a controlled (“delayed”) way. In contrast to absorption via liquid, the effect of the active ingredient can be intentionally adapted to the use. Fast release for the “kick”, and slow, delayed release for a continuous effect (e.g. in order to avoid premature tiredness). Nonwovens whose porosity can be intentionally adjusted are very suitable (e.g. Chembond by varying the binder quantity, compaction of nonwovens with thermoplastic structural elements, selection of fibers with a suitable fiber cross-section, etc.).

Another material for suitable oral pouches are porous films with a suitable pore size and pore density. Microporous films are suitable which are also used in the microfiltration of beverages.

The materials for producing the oral pouches are printed with food-safe inks using flexographic or digital printing. Especially digital printing makes it possible to apply brand- and use-specific multi-color print images even on small surface units. The print can be applied during the production of the surface webs with repetition or directly during the formation of the pouches.

Use of printing inks that release in a controlled manner during use and therefore signal how much active ingredient is still contained.

Pouch with good adhesion to the gingiva and lip so that a slippage or sliding out of the pouch during physical activity is avoided, and the pouch cannot be accidentally swallowed or inhaled.

### DESCRIPTION OF THE DRAWINGS

The invention is explained in the following in more detail using the attached drawings of an exemplary embodiment.

FIG. 1 illustrates a front view of an embodiment of a snus pouch.

FIG. 2 illustrates a rear view of the embodiment of the snus pouch.

FIG. 3 shows a photograph of a an embodiment of a nonwoven with compacted and non-compacted zones for the production of the snus pouch,

FIG. 4 schematically illustrates an enlarged vertical section of a compacted zone within a non-compacted zone.

FIG. 5 schematically illustrates a plurality of separate compacted zones within a contiguous non-compacted zone in a plan view.

FIG. 6 schematically illustrates a plurality of separate non-compacted zones within a contiguous zone in a plan view.

FIG. 7(a)-(e) schematically illustrate top views of different geometries of compacted or non-compacted zones in a plan view.

### DETAILED DESCRIPTION OF THE INVENTION

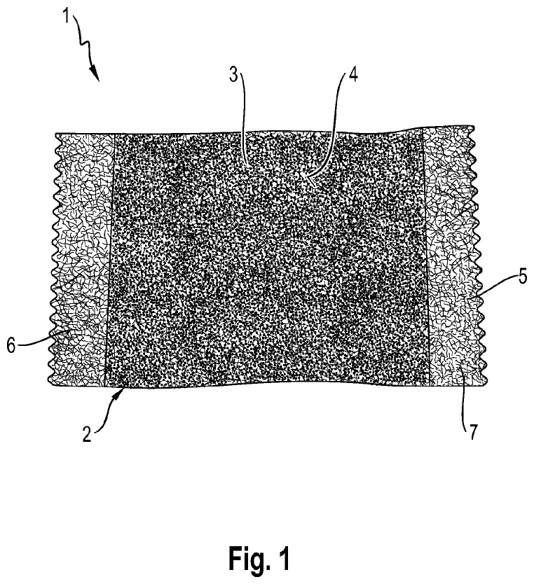

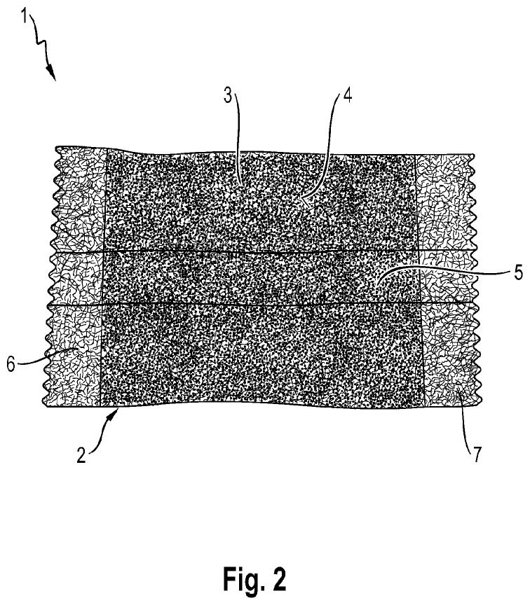

According to FIGS. 1 and 2, a snus pouch 1 comprises a pouch 2 comprising a nonwoven 3 in which a small amount of an active ingredient composition 4 is arranged. The nonwoven 3 is produced from viscose fibers.

The pouch 2 is configured as a tubular pouch. A strip of the nonwoven 3 is folded onto itself at the longitudinal edges and bonded to itself by a longitudinal sealing seam 5. The active ingredient composition 4 is an active ingredient composition in the form of granules which are mixed together from different powders. The active ingredient composition contains caffeine, taurine, sugar and possibly citric acid and sodium citrate as acidifying agents, niacin, nicotinamide, vitamin B6, and vitamin B12. For example, the active ingredient composition contains 80 mg caffeine, 1 g taurine, and 25 g sugar or a fraction (e.g. one-quarter) of the aforementioned amounts.

Furthermore, the two transverse edges of the pouch 2 are connected to each other by transversely oriented sealing seams 6, 7.

During use, the snus pouch 1 is placed behind the lower lip and the upper lip. Saliva from the oral cavity penetrates and releases ingredients from the active ingredient composition 4.

For the nonwoven 3, for example, the product “Nonwova CV 29/vid” by pely-tex GmbH & Co. KG is used. The nonwoven 3 can be used in unchanged form for the production of the pouch. Alternatively, a modified nonwoven 3 is used which can be created in that the product “Nonwova CV 29/viv” is provided with compacted and only non-compacted zones.

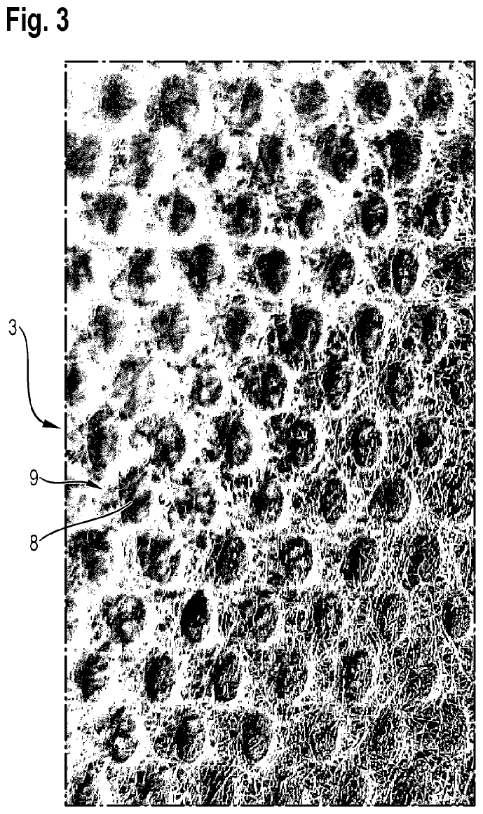

FIG. 3 shows a strongly enlarged photograph of the modified nonwoven 3 for producing the pouch 2 according to FIGS. 1 and 2. The nonwoven 3 has a plurality of separate compacted zones 8 within a contiguous, non-compacted zone 9, which are embossed by means of a calender with an engraving roller and smooth roller. For this purpose, the engraving roller has elevations with a hexagonal, or respectively honeycomb cross-section. The nonwoven 3 is a chemically solidified nonwoven in which the fibers of viscose are provided with a binder that is chemically cross-linked while drying to form a thermoset. When embossing the compacted zones 8, still uncrosslinked parts of the binder are crosslinked in the compacted zones 8 so that the crosslinked binder holds the compacted zones 8 in the compacted state.

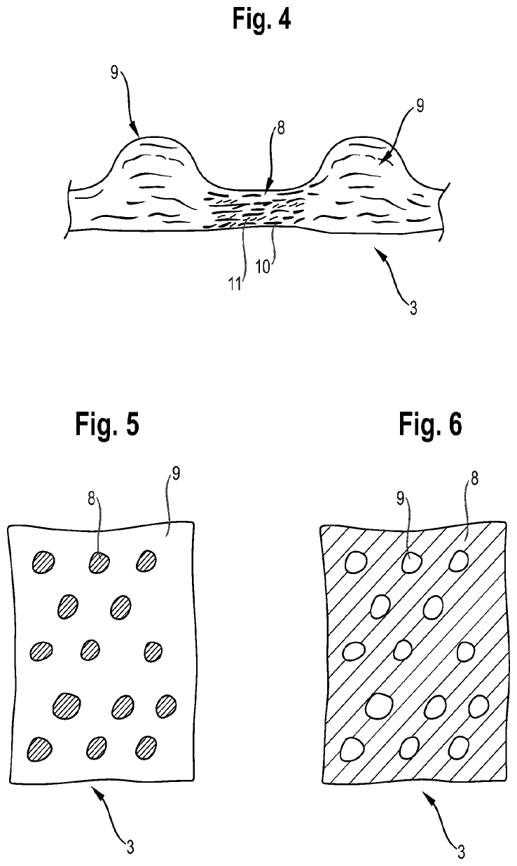

According to FIG. 4, in the compacted zones 9, the fibers 10 lie close together, and the regions between the fibers are at least partially sealed by binder 11 so that the permeability of the nonwoven 3 to flavorings in the compacted zones 8 is much less, or respectively negligible. In the non-compacted zone 9, the nonwoven 3 has its original structure and permeability. The total permeability of the nonwoven 3 is therefore determined jointly by the compacted zones 8 and the non-compacted zone 9.

Accordingly, by means of the selected embossing structure, the permeability of the nonwoven 3 of the snus pouch 1 can be tailored to the respective active ingredient composition 4. In the production of the snus pouches 1 with different tobacco materials 4, the same nonwoven 3 can always be used initially which is provided with an individual embossing depending on the active ingredient composition 4. Different embossing cylinders with which the engraving cylinder of the calender is equipped can be used for this purpose.

According to FIG. 5, a nonwoven 3 can be provided with compacted and non-compacted zones such that it has a plurality of separate compacted zones 8 and a contiguous non-compacted zone 9. This is also the case with the nonwoven 3 of FIG. 3.

According to FIG. 6, alternatively, a nonwoven can be provided with compacted and non-compacted zones such that it has a plurality of separate non-compacted zones 9 within a contiguous compacted zone 8.

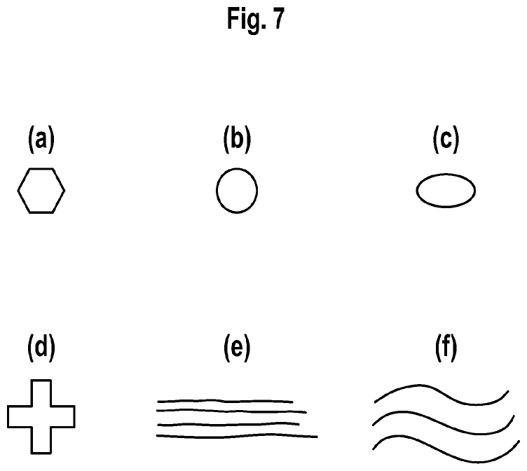

According to FIGS. 7a-f, the compacted or non-compacted zones can have different geometries, in particular polygonal (FIG. 7a), circular (FIG. 7b), oval (FIG. 7c), cruciform (FIG. 7d), linear (FIG. 7e) or wavy (FIG. 7f) geometries.

In the following tables, measurements of the strength, the elongation and the stiffness are shown, in each case in the machine running direction and transversely thereto, as well as static friction forces, static friction coefficients, sealing strengths, sliding friction forces and sliding friction coefficients, as well as air permeabilities, in each case for a conventional nonwoven (standard) and a nonwoven according to the invention provided with compacted and non-compacted zones (embossed pattern), each weighing 29 gsm. The embossed pattern is the nonwoven depicted in FIG. 3. Each of the employed standard measuring methods are indicated in the tables.

According to the measurements, the embossed pattern has weaker MD and CD strengths than the standard. Furthermore, the embossed pattern has less MD and CD elongation than the standard. This is because when embossing the embossed pattern, bonds of the chemically solidified nonwoven are destroyed, and this is only partially compensated for by the cross-linking of binder in the compressed zones.

Finally, in the embossed pattern, the air permeability is reduced compared to the standard. This is due to the fact that the surface of the embossed pattern is closed in the region of the embossing, and this reduces the air permeability in comparison to the standard. Corresponding to the reduction of the air permeability, the flavoring permeability for flavorings in saliva is also reduced.

Nonwova CV 29/viv

| | | | Embossed |
|---|---|---|---|
| Strength MD | | Standard | pattern |
| EDANA WSP 110.4 | [N/50 mm] | 71 | 46 |
| | [N/50 mm] | 68 | 35 |
| | [N/50 mm] | 67 | 43 |
| | [N/50 mm] | 70 | 44 |
| | [N/50 mm] | 69 | 42 |
| Average | [N/50 mm] | 69 | 42 |
| Standard deviation | [N/50 mm] | 1.65 | 4.32 |
| Variation coefficient | [%] | 2.39 | 10.31 |
| min. | [N/50 mm] | 67 | 35 |
| max. | [N/50 mm] | 71 | 46 |

| | | | Embossed |
|---|---|---|---|
| Elongation MD | | Standard | pattern |
| EDANA WSP 110.4 | [%/50 mm] | 8 | 7 |
| | [%/50 mm] | 8 | 8 |
| | [%/50 mm] | 8 | 7 |
| | [%/50 mm] | 8 | 7 |
| | [%/50 mm] | 8 | 7 |
| Average | [%/50 mm] | 8 | 7 |
| Standard deviation | [%/50 mm] | 0.24 | 0.35 |
| Variation coefficient | [%] | 2.98 | 4.98 |
| min. | [%/50 mm] | 8 | 7 |
| max | [%/50 mm] | 8 | 8 |

| | | | Embossed |
|---|---|---|---|
| Rigidity MD | | Standard | pattern |
| EDANA WSP 090.3 | [g] | 214 | 94 |
| | [g] | 215 | 111 |
| | [g] | 246 | 111 |
| | [g] | 209 | 96 |
| | [g] | 221 | 103 |
| Average | [g] | 221 | 103 |
| Standard deviation | [g] | 14.61 | 8.03 |
| Variation coefficient | [%] | 6.61 | 7.80 |
| min. | [g] | 209 | 94 |
| max | [g] | 246 | 111 |

| | | | Embossed |
|---|---|---|---|
| Sealing strength | | Standard | pattern |
| DIN EN 29073-3 | [N/50 mm] | 7.00 | 10.70 |
| | [N/50 mm] | 6.86 | 7.78 |
| | [N/50 mm] | 6.49 | 5.32 |
| | [N/50 mm] | | |
| | [N/50 mm] | | |
| Average | [N/50 mm] | 6.78 | 7.93 |
| Standard deviation | [N/50 mm] | 0.26 | 2.69 |
| Variation coefficient | [%] | 3.88 | 33.95 |
| min. | [N/50 mm] | 6.49 | 5.32 |
| max | [N/50 mm] | 7.00 | 10.70 |

| | | | Embossed |
|---|---|---|---|
| Friction measurement | | Standard | pattern |
| Static friction force (Force static) | [N] | 0.880 | 1.790 |
| Static friction coefficient μ_{S} | | 0.448 | 0.912 |
| Sliding friction force (Force dynamic) | [N] | 0.580 | 1.030 |
| Sliding friction coefficient μ_{D} | | 0.297 | 0.525 |

Nonwova CV 29/viv

| | | | Embossed |
|---|---|---|---|
| Strength CD | | Standard | pattern |
| EDANA WSP 110.4 | [N/50 mm] | 17 | 15 |
| | [N/50 mm] | 17 | 12 |
| | [N/50 mm] | 17 | 12 |
| | [N/50 mm] | 18 | 16 |
| | [N/50 mm] | 17 | 14 |
| Average | [N/50 mm] | 17 | 14 |
| Standard deviation | [N/50 mm] | 0.53 | 1.82 |
| Variation coefficient | [%] | 3.07 | 13.29 |
| min. | [N/50 mm] | 17 | 12 |
| max | [N/50 mm] | 18 | 16 |

| | | | Embossed |
|---|---|---|---|
| Elongation CD | | Standard | pattern |
| EDANA WSP 110.4 | [%/50 mm] | 30 | 30 |
| | [%/50 mm] | 37 | 28 |
| | [%/50 mm] | 35 | 25 |
| | [%/50 mm] | 38 | 32 |
| | [%/50 mm] | 35 | 28 |
| Average | [%/50 mm] | 35 | 28 |
| Standard deviation | [%/50 mm] | 2.82 | 2.60 |
| Variation coefficient | [%] | 8.09 | 9.17 |
| min. | [%/50 mm] | 30 | 25 |
| max | [%/50 mm] | 38 | 32 |

| | | | Embossed |
|---|---|---|---|
| Elongation MD | | Standard | pattern |
| EDANA WSP 090.3 | [g] | 57 | 48 |
| | [g] | 63 | 41 |
| | [g] | 53 | 43 |
| | [g] | 57 | 41 |
| | [g] | 58 | 43 |
| Average | [g] | 58 | 43 |
| Standard deviation | [g] | 3.57 | 2.86 |
| Variation coefficient | [%] | 6.21 | 6.62 |
| min. | [g] | 53 | 41 |
| max | [g] | 63 | 48 |

| | | | Embossed |
|---|---|---|---|
| Air permeability | | Standard | pattern |
| EDANA WSP 070.1 | [l/m²/s] | 2,780 | 1,920 |
| 125 Palat 5 cm² test area | [l/m²/s] | 2,960 | 1,750 |
| | [l/m²/s] | 2,620 | 1,620 |
| | [l/m²/s] | 2,860 | 1,610 |
| | [l/m²/s] | 2,920 | 1,490 |
| Average | [l/m²/s] | 2,828 | 1,678 |
| Standard deviation | [l/m²/s] | 134.61 | 163.62 |
| Variation coefficient | [%] | 4.76 | 9.75 |
| min. | [l/m²/s] | 2,620 | 1,490 |
| max | [l/m²/s] | 2,960 | 1,920 |

1-21. (canceled)

22. A pouch for placement in an oral vestibule for absorption of an active ingredient composition by a human, comprising:
a pouch sleeve comprised of a material which is permeable to saliva;
an active ingredient composition comprising caffeine and taurine; and
an imprint comprised of a food-safe ink and positioned on an exterior surface of the pouch sleeve,
wherein the imprint, the permeability of the material of the pouch sleeve, and the active ingredient composition are configured such that, because of an effect of the saliva, the imprint is gradually released from the exterior surface of the pouch due to contact with the saliva,
wherein the saliva acts to extract the active ingredient composition from the pouch and also acts on the imprint so that the imprint is no longer visually perceptible just when the active ingredient composition is substantially or completely extracted from the pouch,
wherein the imprint acts as by the saliva a visual indicator of a consumption status of the active ingredient.

23. The pouch according to claim 22, wherein the active ingredient composition further comprises one or more of: (i) sugar; (ii) dextrose; (iii) sweetener; (iv) carbonic acid; (v) citric acid; (vi) sodium citrate; (vii) glucuronolactone; (viii) vitamins (e.g. vitamin B6 and/or vitamin B12); (ix) mineral substances; (x) flavoring agents; (xi) nicotine; (xii) niacin; (xiii) nicotinamide; (xiv) acetylsalicylic acid; and (xv) colorants.

24. The pouch according to claim 22, further comprising at least one gastric acid-sensitive active ingredient.

25. The pouch according to claim 22, wherein the active ingredient composition is configured to dissolve in the saliva during a given exposure time, wherein the active ingredient composition is released until an end of the given exposure time.

26. The pouch according to claim 25, wherein the given exposure time is up to one hour.

27. The pouch according to claim 22, further including granules comprising the active ingredient composition.

28. The pouch according to claim 27, wherein the granules further comprise cellulose fiber pulp.

29. The pouch according to claim 27, wherein the granules comprise plant fibers which are loaded with at least one of: (i) the active ingredients; and (ii) other ingredients.

30. The pouch according to claim 27, wherein the granules include plant fibers comprising at least one of: (i) caffeine; (ii) taurine; and (iii) other ingredients as original constituents.

31. The pouch according to claim 22, wherein the pouch sleeve comprises a nonwoven.

32. The pouch according to claim 31, wherein the nonwoven at least partially comprises cellulosic fibers.

33. The pouch according to claim 32, wherein the cellulosic fibers comprise one or more of: (i) viscose fibers; (ii) lyocell fibers; and (iii) cotton fibers.

34. The pouch according to claim 31, wherein the nonwoven is chemically solidified.

35. The pouch according to claim 31, wherein the nonwoven comprises a sealable component.

36. The pouch according to claim 31, wherein a permeability of the nonwoven to saliva is controlled based on at least one of:
(i) a election of a fleece forming process;
(ii) a selection of a type, a titer and a cross-section of fibers;
(iii) a selection of a type and an amount of a binder; and
(iv) adjustment of a pore size distribution and a pore density of the nonwoven by compaction of the nonwoven.

37. The pouch according to claim 22, wherein the pouch sleeve is a porous film.

38. A method for oral absorption of an active ingredient by the human, comprising:
structuring an oral pouch according to claim 22;
placing the oral pouch in the oral vestibule of an oral cavity;
extracting the active ingredient composition from the oral pouch by means of the saliva;
wherein the active ingredient composition is absorbed through a mucous membrane and enters a bloodstream of the human, and
wherein the active ingredient composition manifests a stimulating effect on the human,
wherein the active ingredient composition and a color of the imprint are released from the pouch sleeve at the same time by means of the saliva, and
wherein just when the imprint on the pouch surface is no longer visually perceptible, the active ingredient composition is exhausted.

39. A use of the pouch according to the method of claim 38 during an endurance sport or activity in which consumption of stimulating beverages or other forms of administration of stimulating agents is impossible or difficult,
wherein when the pouch is placed in the oral vestibule, the active ingredient composition is extracted from the oral pouch by means of the saliva and is absorbed into the bloodstream of the human to manifest a stimulating effect.
